(19) United States
(12) Patent Application Publication
(10) Pub. No.: US 2022/0128371 A1
(43) Pub. Date: Apr. 28, 2022

(54) INFORMATION PROCESSING APPARATUS, INFORMATION PROCESSING METHOD, AND VEHICLE

(71) Applicant: TOYOTA JIDOSHA KABUSHIKI KAISHA, Toyota-shi Aichi-ken (JP)

(72) Inventors: Yu Nagata, Chofu-shi Tokyo (JP); Shin Sakurada, Toyota-shi Aichi-ken (JP); Satoshi Komamine, Nagoya-shi Aichi-ken (JP); Yusuke Sato, Nagoya-shi Aichi-ken (JP); Hiromitsu Fujii, Kariya-shi Aichi-ken (JP)

(73) Assignee: TOYOTA JIDOSHA KABUSHIKI KAISHA, Toyota-shi Aichi-ken (JP)

(21) Appl. No.: 17/508,479

(22) Filed: Oct. 22, 2021

(30) Foreign Application Priority Data
Oct. 23, 2020 (JP) 2020-178299

(51) Int. Cl. G01C 21/34; G01C 21/36

(52) U.S. Cl. CPC G01C 21/3461; G01C 21/3691; G01C 21/3492

(57) ABSTRACT

In an information processing apparatus, a control unit acquires information on a passage route that is a route through which a user of a facility included in a predetermined area passes. The control unit generates, based on the information on the passage route, information on a recommended route that is a vehicle traveling route recommended within the predetermined area. The control unit transmits the information on the recommended route to a vehicle scheduled to travel within the predetermined area.

### CROSS-REFERENCE TO RELATED APPLICATION

This application claims priority to Japanese Patent Application No. 2020-178299 filed on Oct. 23, 2020, incorporated herein by reference in its entirety.

### BACKGROUND

### 1. Technical Field

The present disclosure relates to an information processing apparatus, an information processing method, and a vehicle.

### 2. Description of Related Art

A system that determines whether there is a possibility that a user (for example, a commuter student) moves around in the area of a facility, such as a school, based on information on a time range in which the user moves around in the area of the facility has been proposed. In such a system, when it is determined that there is a possibility that the user may move around in the area of the facility, a process for calling attention to a vehicle approaching the facility is also executed (see, for example, Japanese Unexamined Patent Application Publication No. 2004-234320).

### SUMMARY

The present disclosure provides an information processing apparatus, an information processing method, and a vehicle that can contribute to an improvement of traffic safety of a user of a facility.

A first aspect of the present disclosure is an information processing apparatus that manages an operation of a vehicle. The information processing apparatus includes a control unit configured to acquire information on a passage route that is a route through which a user of a facility included in a predetermined area passes, generate, based on the information on the passage route, information on a recommended route that is a vehicle traveling route recommended within the predetermined area, and transmit the information on the recommended route to the vehicle scheduled to travel within the predetermined area.

In the first aspect, the control unit may extract a plurality of route candidates that are candidates of routes through which the vehicle is allowed to pass when traveling within the predetermined area, calculate, based on the information on the passage route, a score on a safety level when the vehicle is assumed to travel on each of the route candidates, and set, as the recommended route, a route candidate having the highest score from among the route candidates.

In the first aspect, when a plurality of users and a plurality of passage routes are present, the information on the passage route may include information on a time range in which at least one of the users passes through each of the passage routes. The control unit may acquire a scheduled traveling time range that is a time range in which the vehicle is scheduled to travel in the predetermined area, predict, based on the information on the passage route, the number of passers-by from among the users in the scheduled traveling time range for each of the route candidates, and calculate, based on the number of passers-by from among the users for each of the route candidates, a score for each of the route candidates.

In the first aspect, the control unit may calculate the score such that the score is larger when the number of passers-by from among the users for each of the route candidates is small than when the number is large.

In the first aspect, when a plurality of users and a plurality of passage routes are present, the information on the passage route may include information on a time range in which at least one of the users passes through each of the passage routes. The control unit may acquire a scheduled traveling time range that is a time range in which the vehicle is scheduled to travel in the predetermined area, acquire age information that is information on an age of each of the users, predict, based on the information on the passage route and the age information, an age distribution of the users in the scheduled traveling time range for each of the route candidates, and calculate, based on the age distribution of the users for each of the route candidates, the score for each of the route candidates.

In the first aspect, the control unit may calculate the score such that the score is higher when a proportion of a predetermined young age group in the age distribution of the users for each of the route candidates is small than when the proportion is large.

In the first aspect, the facility may be an elementary school, and the user may be a child who commutes to and/or from the elementary school. The predetermined young age group may be an age group corresponding to lower grades of the elementary school.

In the first aspect, the control unit may calculate the score such that the score is higher when the average age in the age distribution of the users for each of the route candidates is high than when the average age is low.

In the first aspect, the facility may be an elementary school, and the user may be a child who commutes to and/or from the elementary school.

In the first aspect, when a plurality of users and a plurality of passage routes are present, the information on the passage route may include information on a time range in which at least one of the users passes through each of the passage routes. The control unit may acquire a scheduled traveling time range that is a time range in which the vehicle is scheduled to travel in the predetermined area, predict, based on the information on the passage route, the number of passers-by from among the users in the scheduled traveling time range for each of the route candidates, acquire age information that is information on an age of each of the users, predict, based on the information on the passage route and the age information, an age distribution of the users in the scheduled traveling time range for each of the route candidates, and calculate, based on the number of passers-by from among the users and the age distribution for each of the route candidates, the score for each of the route candidates.

In the first aspect, the control unit may calculate the score such that the score becomes higher as the number of passers-by from among the users for each of the route candidates is smaller and a proportion of a predetermined young age group in the age distribution of the users for each of the route candidates is smaller.

In the first aspect, the facility may be the elementary school, and the user may be the child who commutes to and/or from the elementary school. The predetermined young age group may be the age group corresponding to the lower grades of the elementary school.

In the first aspect, the control unit may calculate the score such that the score becomes higher as the number of passers-by from among the users for each of the route candidates is smaller and the average age in the age distribution of the users for each of the route candidates is higher.

In the first aspect, the facility may be the elementary school, and the user may be the child who commutes to and/or from the elementary school.

A second aspect of the present disclosure is an information processing method of managing an operation of a vehicle. The information processing method includes a first step of acquiring information on a passage route that is a route through which a user of a facility included in a predetermined area passes, a second step of generating, based on the information on the passage route, information on a recommended route that is a vehicle traveling route recommended within the predetermined area, and a third step of transmitting the information on the recommended route to the vehicle scheduled to travel within the predetermined area. The first step, the second step, and the third step are executed by a computer.

In the second aspect, the second step may include a step of extracting a plurality of route candidates that are candidates of routes through which the vehicle is allowed to pass when traveling within the predetermined area, a step of calculating, based on the information on the passage route, a score on a safety level when the vehicle is assumed to travel on each of the route candidates, and a step of setting, as the recommended route, a route candidate having the highest score from among the route candidates.

In the second aspect, when a plurality of users and a plurality of passage routes are present, the information on the passage route may include information on a time range in which at least one of the users passes through each of the passage routes. The step of calculating the score may include a step of acquiring a scheduled traveling time range that is a time range in which the vehicle is scheduled to travel in the predetermined area, a step of predicting, based on the information on the passage route, the number of passers-by from among the users in the scheduled traveling time range for each of the route candidates, and a step of calculating, based on the number of passers-by from among the users for each of the route candidates, the score for each of the route candidates.

In the second aspect, when a plurality of users and a plurality of passage routes are present, the information on the passage route may include information on a time range in which at least one of the users passes through each of the passage routes. The step of calculating the score may include a step of acquiring a scheduled traveling time range that is a time range in which the vehicle is scheduled to travel in the predetermined area, a step of acquiring age information that is information on an age of each of the users, a step of predicting, based on the information on the passage route and the age information, an age distribution of the users in the scheduled traveling time range for each of the route candidates, and a step of calculating, based on the age distribution of the users for each of the route candidates, the score for each of the route candidates.

In the second aspect, when a plurality of users and a plurality of passage routes are present, the information on the passage route may include information on a time range in which at least one of the users passes through each of the passage routes. The step of calculating the score may include a step of acquiring a scheduled traveling time range that is a time range in which the vehicle is scheduled to travel in the predetermined area, a step of predicting, based on the information on the passage route, the number of passers-by from among the users in the scheduled traveling time range for each of the route candidates, a step of acquiring age information that is information on an age of each of the users, a step of predicting, based on the information on the passage route and the age information, an age distribution of the users in the scheduled traveling time range for each of the route candidates, and a step of calculating, based on the number of passers-by from among the users and the age distribution for each of the route candidates, the score for each of the route candidates.

A vehicle according to a third aspect of the present disclosure includes a control unit configured to acquire information on a passage route that is a route through which a user of a facility included in a predetermined area passes, set, based on the information on the passage route, a recommended route that is a vehicle traveling route recommended within the predetermined area, and execute an operation by which the vehicle travels within the predetermined area according to the recommended route.

Moreover, another aspect of the present disclosure may be an information processing program for causing a computer to execute the above-described information processing method, or a non-transitory storage medium storing the information processing program.

With each aspect of the present disclosure, it is possible to provide a technology that can contribute to an improvement of traffic safety of a user of a facility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of an operation management system;

FIG. 2 is a diagram illustrating a hardware configuration example of the operation management system;

FIG. 3 is a block diagram illustrating a functional configuration example of a vehicle included in the operation management system;

FIG. 4 is a block diagram illustrating a functional configuration example of a server apparatus included in the operation management system;

FIG. 5 is a diagram illustrating a configuration example of a route information table in a first embodiment;

FIG. 6 is a flowchart illustrating a flow of processing executed in the server apparatus in the first embodiment;

FIG. 7 is a diagram illustrating a configuration example of a route information table in a second embodiment; and

FIG. 8 is a flowchart illustrating a flow of processing executed in the server apparatus in the second embodiment.

### DETAILED DESCRIPTION OF EMBODIMENTS

The present disclosure is applied to a system (hereinafter, sometimes referred to as an “operation management system”) that manages an operation of a vehicle traveling in a predetermined area that includes facilities, such as a school. The operation management system includes an information processing apparatus that manages a traveling route of the vehicle within the predetermined area.

In the information processing apparatus of the operation management system, a control unit acquires information on a route through which a user of the facilities included in the predetermined area passes (a passage route). Here, the “user” is a user whose learning level in terms of traffic safety may be low, such as an elementary school student, or a user who may have a low physical ability to avoid collision with a vehicle, such as an elderly person or a disabled person. Here, the “facilities” may be, for example, facilities, such as a school which an elementary school student and the like commute to and from, and a specially assisted school which a disabled person and the like commute to and from, or facilities used by an elderly person. The “predetermined area” is an area including a route through which a user can pass on foot or in a wheelchair when using facilities, such as a school commuting zone.

Upon acquiring information on a passage route of the user (hereinafter, sometimes referred to as “passage route information”), the control unit generates information on a vehicle traveling route (a recommended route) recommended within the predetermined area (hereinafter, sometimes referred to as “recommended information”) based on the acquired passage route information. As such, it is possible to set, as the recommended route, a route on which a minor accident between the user and the vehicle is unlikely to occur, such as a route on which the traffic volume of users (the number of passers-by) is zero and a route on which the number of passers-by from among the users is relatively small. The recommended information may include information that recommends a driver to slowly travel when passing through a point through which the user is passing. Moreover, the recommended information may include information that recommends a driver to temporarily pause before a point through which the user is passing. Such recommended information is transmitted to a vehicle scheduled to travel in the predetermined area. As such, the vehicle can travel within the predetermined area according to the recommended route.

Therefore, with the present disclosure, it is possible to contribute to an improvement of traffic safety of a user of facilities within a predetermined area.

Here, the control unit may set, as the recommended route, a route candidate having the highest score on a safety level from among a plurality of routes (route candidates) through which the vehicle can pass when traveling in the predetermined area. The “score on the safety level” may be, for example, an evaluation value on the safety level when the vehicle is assumed to travel on each of a plurality of route candidates. It is determined that the safety level during traveling of the vehicle becomes higher as a score of a route candidate is higher.

Here, when a plurality of users and a plurality of passage routes are present, the passage route information may include information on a time range in which at least one of the users passes through each of the passage routes. In that case, the control unit may calculate the score of each route candidate according to the following procedures:

(1-1) Acquire a time range (a scheduled traveling time range) in which the vehicle is scheduled to travel in the predetermined area.

(1-2) Predict, based on the passage route information, the number of passers-by from among the users for each route candidate in the scheduled traveling time range.

(1-3) Calculate the score of each of the route candidates based on the number of passers-by for each route candidate.

In the procedure (1-3), the control unit may calculate the score such that the score is higher when the number of passers-by for each route candidate is small than when the number is large. In other words, the control unit may calculate the score such that the score becomes higher as the number of passers-by from among the users on a route candidate is smaller.

In addition, when a plurality of users and a plurality of passage routes are present, the passage route information may include the information on the time range in which at least one of the users passes through each of the passage routes. In that case, when information (age information) on the age of the user can be acquired, the control unit may calculate the score of each route candidate according to the following procedures:

(2-1) Acquire the scheduled traveling time range.

(2-2) Predict, based on the passage route information and the age information, an age distribution of the users for each route candidate in the scheduled traveling time range.

(2-3) Calculate the score of each of the route candidates based on the age distribution for each route candidate.

When the facilities are an elementary school and the user is a child who commutes to and/or from the elementary school, in the procedure (2-3), the control unit may calculate the proportion of a predetermined young age group (for example, the age group corresponding to lower grades) in the age distribution for each route candidate. The control unit may calculate the score such that the score is larger when the calculated proportion is small than when the proportion is large. In other words, the control unit may calculate the score such that the score becomes higher as the proportion of the users in the predetermined young age group from among the users passing through each route candidate in the scheduled traveling time range is smaller. Alternatively, the control unit may calculate the score such that the score is higher when the average age in the age distribution for each route candidate is high than when the average age is low. In other words, the control unit may calculate the score such that the score becomes higher as the average age of the users passing through each route candidate in the scheduled traveling time range is higher. Here, the “age distribution” may be, for example, the number of passers-by for each age or each grade from among the users.

Alternatively, when a plurality of users and a plurality of passage routes are present, the passage route information may include the information on the time range in which at least one of the users passes through each of the passage routes. In that case, when the information (the age information) on the age of the user can be acquired, the control unit may calculate the score of each route candidate according to the following procedures:

(3-1) Acquire the scheduled traveling time range.

(3-2) Predict, based on the passage route information, the number of passers-by for each route candidate in the scheduled traveling time range.

(3-3) Predict, based on the passage route information and the age information, the age distribution for each route candidate in the scheduled traveling time range.

(3-4) Calculate the score of each of the route candidates based on the number of passers-by and the age distribution for each route candidate.

In the procedure (3-4), the control unit may calculate the score such that the score becomes higher as the number of passers-by for each route candidate is smaller, and the proportion of the predetermined young age group in the age distribution for each route candidate is smaller (or as the average age is higher).

When the score of each route candidate is calculated using the various procedures described above, a route that does not pass through the following routes can be set as the recommended route:

(Route 1) A route through which a relatively large number of passers-by from among the users pass

(Route 2) A route with a relatively large proportion of the users in the predetermined young age group

(Route 3) A route through which the users having a relatively low average age pass

(Route 4) A route with a relatively large number of passers-by from among the users, and a relatively large proportion of the users in the predetermined young age group (or a relatively low average age of the users)

As such, it is possible to reduce the probability of an occurrence of a minor accident between the vehicle traveling in the predetermined area and the user, or the like.

### First Embodiment

Hereinafter, embodiments of the present disclosure will be described in detail with reference to drawings. Unless otherwise specified, dimensions, materials, shapes, and relative arrangements of the components described in the present embodiment are not intended to limit the technical scope of the present disclosure.

In the present embodiment, an example in which the present disclosure is applied to an operation management system that manages an operation of a vehicle traveling in a predetermined area will be described. The predetermined area in this example is an area including a location of an elementary school, and corresponds to an area (for example, a school commuting zone) including a route through which elementary school students (users) attending the elementary school can pass when going to and leaving school. The “predetermined area” may be an area including all or a part of the school commuting zone. Moreover, the predetermined area is not limited to the above example, and may be an area including a route through which a person vulnerable to a traffic accident can pass. For example, the predetermined area may be an area including the location of a specially assisted school which a disabled person and the like commute to and from or facilities used by an elderly person, or an area including a route through which the user of the facilities can pass on foot or in a wheelchair or the like.

### Overview of Traveling Management System

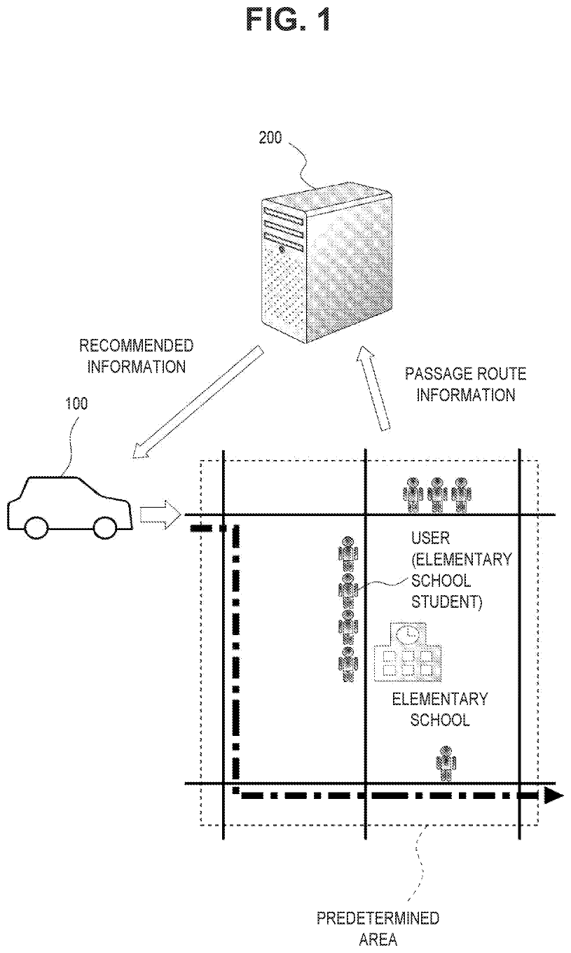

FIG. 1 is a diagram illustrating an overview of the operation management system according to the present embodiment. In an example illustrated in FIG. 1, the operation management system includes a vehicle 100 and a server apparatus 200. In this example, the vehicle 100 is an automobile capable of autonomously traveling on a road by autonomous driving, and is operated based on various commands or the like from an occupant or the server apparatus 200. The server apparatus 200 manages the operation of the vehicle 100 scheduled to travel in the predetermined area. In this example, the server apparatus 200 generates information (recommended information) on a vehicle traveling route (recommended route) recommended within the predetermined area. The recommended information generated by the server apparatus 200 is transmitted to the vehicle 100 scheduled to travel in the predetermined area. The vehicle 100 that has received the recommended information travels within the predetermined area according to the recommended route. In FIG. 1, only one predetermined area is illustrated, but there may be a plurality of predetermined areas under the control of the server apparatus 200.

### Hardware Configuration of Operation Management System

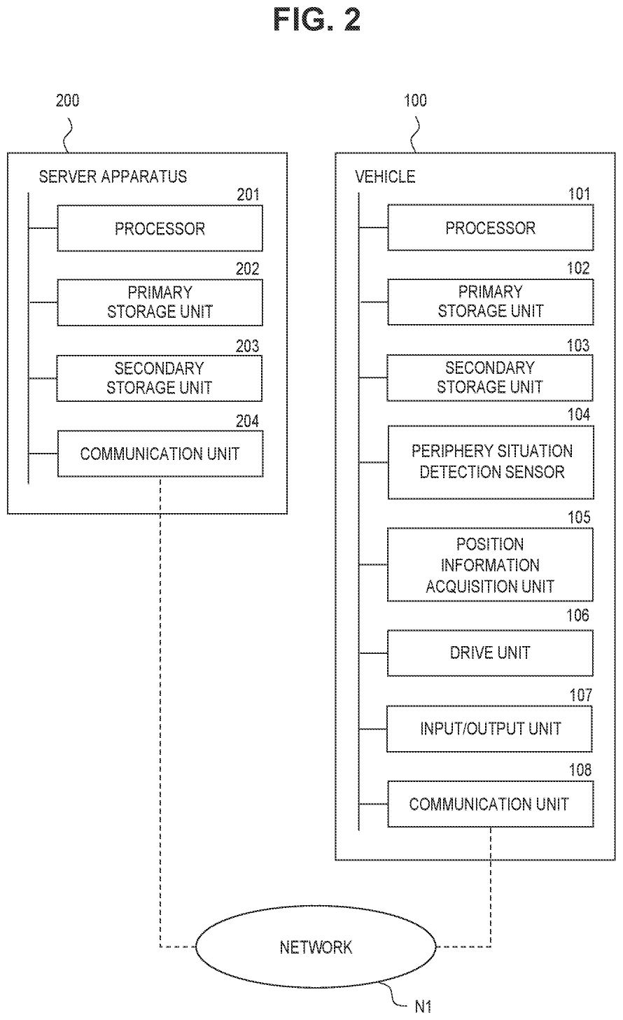

Next, components of the operation management system will be described in detail. FIG. 2 is a diagram illustrating a hardware configuration example of the vehicle 100 and the server apparatus 200 illustrated in FIG. 1. In an example illustrated in FIG. 2, only one vehicle 100 is illustrated, but there may be a plurality of vehicles 100 scheduled to travel in the predetermined area.

The vehicle 100 is a vehicle capable of autonomously traveling on the road by autonomous driving, and is driven by, for example, an electric motor as a prime mover. The prime mover of the vehicle 100 is not limited to the electric motor, and may be an internal combustion engine or a hybrid mechanism having the internal combustion engine and the electric motor. Such a vehicle 100 includes a processor 101, a primary storage unit 102, a secondary storage unit 103, a periphery situation detection sensor 104, a position information acquisition unit 105, a drive unit 106, an input/output unit 107, a communication unit 108, and the like.

An example of the processor 101 includes a central processing unit (CPU) or a digital signal processor (DSP). The processor 101 controls the vehicle 100 and executes an operation of various information processes.

The primary storage unit 102 includes, for example, a random access memory (RAM) and a read-only memory (ROM). The secondary storage unit 103 includes, for example, an erasable programmable ROM (EPROM), or a hard disk drive (HDD). The secondary storage unit 103 can include a removable medium, that is, a portable recording medium. The removable medium may be a disc recording medium, such as a universal serial bus (USB) memory, a compact disc (CD), and a digital versatile disc (DVD). The secondary storage unit 103 stores various programs, various pieces of data, various tables, and the like in a readable and writable manner. The program stored in the secondary storage unit 103 includes an operating system (OS) and the like. A part or all of the information may be stored in the primary storage unit 102.

The vehicle 100 includes one or a plurality of periphery situation detection sensors 104 that sense the periphery of the vehicle 100, and typically include a stereo camera, a laser scanner, a laser detection and ranging (LiDAR), a radar, or the like. Information acquired by the periphery situation detection sensor 104 is transferred to the processor 101.

The position information acquisition unit 105 is a device that acquires a current position of the vehicle 100, and typically includes a Global Positioning System (GPS) receiver and the like. The position information acquisition unit 105 acquires the current position of the vehicle 100 at a predetermined cycle. The position information acquired by the position information acquisition unit 105 is transmitted to the server apparatus 200 via a communication unit 108 to be described below. In other words, the position information of the vehicle 100 is transmitted from the vehicle 100 to the server apparatus 200 at a predetermined cycle. As such, the server apparatus 200 can recognize the current position of each vehicle 100.

The drive unit 106 is a device that causes the vehicle 100 to travel. The drive unit 106 includes, for example, an electric motor as a prime mover, a battery that supplies power to the electric motor, a control device that controls the vehicle 100, a steering device that changes a steering angle of wheels of the vehicle 100, and the like.

The input/output unit 107 is a device that receives an operation of the occupant and presents various pieces of information to the occupant. The input/output unit 107 includes, for example, a touch panel display including a liquid crystal display and a touch panel, a physical push button, a microphone through which sound can be input, or a speaker capable of outputting sound.

The communication unit 108 is a device that connects the vehicle 100 to a network N1. The communication unit 108 is connected to the network N1 using, for example, mobile communication, such as Fifth Generation (5G) and Long-term Evolution (LTE). Alternatively, the communication unit 108 may be connected to the network N1 using narrow band communication, such as dedicated short-range communications (DSRC) or Wi-Fi®. As such, the communication unit 108 can communicate with another apparatus (for example, the server apparatus 200) via the network N1. For example, the communication unit 108 can transmit current position information and the like acquired by the position information acquisition unit 105 to the server apparatus 200 via the network N1, or can receive the recommended information transmitted from the server apparatus 200 via the network N1. Here, an example of the network N1 includes a wide area network (WAN), which is a world-wide public communication network, such as the Internet, or other communication networks.

The hardware configuration of the vehicle 100 is not limited to the example illustrated in FIG. 2, and the components may be omitted, replaced, or added as appropriate. Further, a series of processes executed in the vehicle 100 can be implemented by hardware, but can also be implemented by software.

The server apparatus 200 is an apparatus that manages the operation of the vehicle 100 scheduled to travel in the predetermined area, and corresponds to the “information processing apparatus” according to the present disclosure. The server apparatus 200 has a general computer configuration. In other words, the server apparatus 200 includes a processor 201, a primary storage unit 202, a secondary storage unit 203, a communication unit 204, and the like. The processor 201, the primary storage unit 202, the secondary storage unit 203, the communication unit 204, and the like are connected to one another via buses. Since the processor 201, the primary storage unit 202, and the secondary storage unit 203 are the same as those of the vehicle 100, the description thereof will be omitted. However, the program stored in the secondary storage unit 203 also includes a program that generates the recommended information in addition to a program, such as the operating system. The communication unit 204 is a device that transmits and receives information between an external device and the server apparatus 200. Examples of the communication unit 204 include a local area network (LAN) interface board or a wireless communication circuit for wireless communication. The LAN interface board or the wireless communication circuit is connected to the network N1.

The hardware configuration of the server apparatus 200 is not limited to the example illustrated in FIG. 2, and the components may be omitted, replaced, or added as appropriate. Further, a series of processes executed in the server apparatus 200 can be implemented by hardware, but can also be implemented by software.

### Functional Configuration of Vehicle

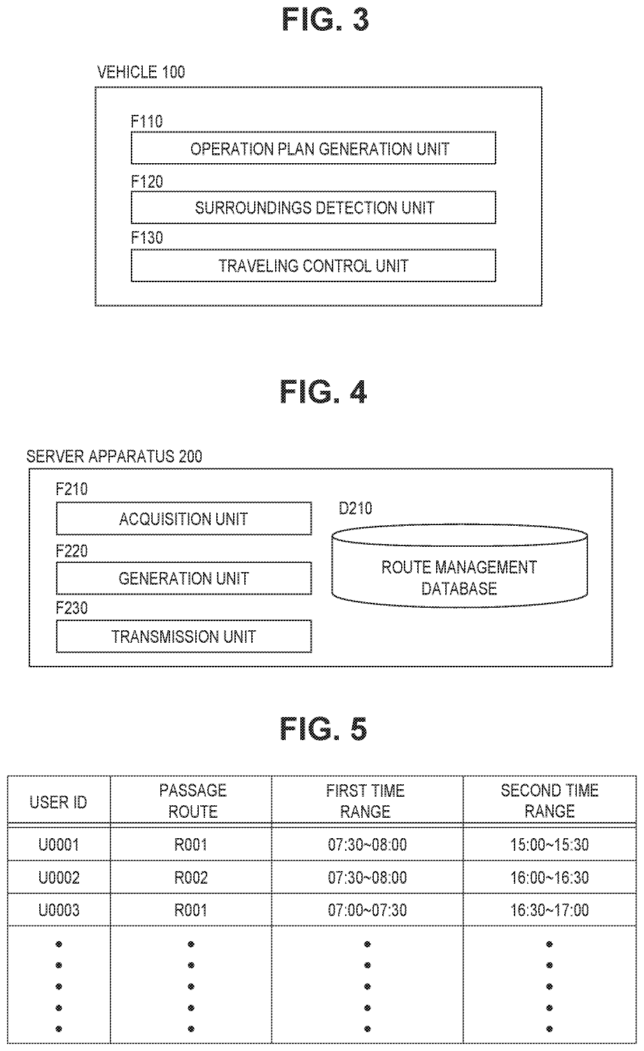

Here, a functional configuration of the vehicle 100 will be described with reference to FIG. 3. In this example, as illustrated in FIG. 3, the vehicle 100 includes, as functional components thereof, an operation plan generation unit F110, a surroundings detection unit F120, and a traveling control unit F130. The functions of these functional components are implemented when the processor 101 executes the program stored in the primary storage unit 102 or the secondary storage unit 103. Any one or a part of the operation plan generation unit F110, the surroundings detection unit F120, and the traveling control unit F130 may be formed by a hardware circuit. Further, each process executed by the operation plan generation unit F110 may be executed by another computer (for example, a server apparatus 200) connected to the network N1.

The operation plan generation unit F110 generates an operation plan of the vehicle 100 based on various commands and the like from the occupant or the server apparatus 200. The operation plan is data that defines a route (a scheduled traveling route) on which the vehicle 100 is scheduled to travel from a departure point to a destination, and processes to be executed by the vehicle 100 in a part or all of the scheduled traveling route.

Examples of the data included in the operation plan include the following.

(1) Data representing the scheduled traveling route by a set of road links

(2) Data indicating the processes to be executed by the vehicle 100 at any point on the scheduled traveling route

Here, the “scheduled traveling route” is generated by the operation plan generation unit F110. For example, the operation plan generation unit F110 generates a provisional scheduled traveling route based on the destination that is input by the occupant using the input/output unit 107, the current position (the departure point) of the vehicle 100, and map data stored in the secondary storage unit 103 and the like. The operation plan generation unit F110 transmits information on the generated provisional scheduled traveling route (hereinafter, sometimes referred to as “provisional information”) to the server apparatus 200 via the communication unit 108. At that time, when the provisional scheduled traveling route passes through a predetermined area under the management of the server apparatus 200, the server apparatus 200 sends the recommended information as a reply. The operation plan generation unit F110 corrects the provisional scheduled traveling route based on the recommended information that is received from the server apparatus 200, and sets the corrected route as an official scheduled traveling route. On the other hand, when the scheduled traveling route does not pass through the predetermined area, the server apparatus 200 sends approval information as a reply. Here, the “approval information” is information indicating that it is not necessary to correct the provisional scheduled traveling route. When the communication unit 108 receives such approval information, the operation plan generation unit F110 sets the provisional scheduled traveling route as it is as the official scheduled traveling route. Moreover, here, the “any point” may be, for example, a point through which the user is passing through the scheduled traveling route. The processing to be executed by the vehicle 100 at the above-described any point includes, for example, causing the vehicle 100 to slowly travel (controlling a traveling speed of the vehicle 100 such that the speed is equal to or lower than the speed recommended by the server apparatus 200) and causing the vehicle 100 to temporarily pause, but is not limited thereto.

The surroundings detection unit F120 detects the surroundings of the vehicle 100 based on the data acquired by the periphery situation detection sensor 104. Examples of detection targets include the number and positions of vehicle lanes, the number and positions of vehicles present around the vehicle 100, and the number and positions of obstacles (pedestrians, structures, and the like) present around the vehicle 100, road structures, and road markings. The detection targets are not limited to the above, and may be any object as long as it is necessary for the vehicle 100 to autonomously travel. Moreover, the surroundings detection unit F120 may track a detected object. For example, the surroundings detection unit F120 may obtain a relative speed of the object from a difference between coordinates of the object that is detected one step before and current coordinates of the object.

The traveling control unit F130 controls traveling of the vehicle 100 based on the operation plan generated by the operation plan generation unit F110, the surroundings data generated by the surroundings detection unit F120, and the position information of the vehicle 100 acquired by the position information acquisition unit 105. For example, the traveling control unit F130 causes the vehicle 100 to travel according to the scheduled traveling route generated by the operation plan generation unit F110. At that time, the traveling control unit F130 causes the vehicle 100 to travel such that an obstacle does not enter the predetermined safety area centered on the vehicle 100. A well-known method can be employed as a method of causing the vehicle 100 to autonomously travel. In addition, the traveling control unit F130 also has a function of controlling the traveling of the vehicle 100 according to a command from the occupant or the server apparatus 200.

The functional components of the vehicle 100 are not limited to the example illustrated in FIG. 3, and may be added, changed, or deleted as appropriate.

### Functional Configuration of Server Apparatus

Next, a functional configuration of the server apparatus 200 will be described with reference to FIG. 4. In this example, as illustrated in FIG. 4, the server apparatus 200 includes, as functional components thereof, an acquisition unit F210, a generation unit F220, a transmission unit F230, and a route management database D210. Functions of the acquisition unit F210, the generation unit F220, and the transmission unit

F230 are implemented when the processor 201 executes a program stored in the primary storage unit 202 or the secondary storage unit 203. Any one or a part of the acquisition unit F210, the generation unit F220, and the transmission unit F230 may be formed by a hardware circuit. Further, a part of the processes executed by any one of the acquisition unit F210, the generation unit F220, and the transmission unit F230 may be executed by another computer connected to the network N1. For example, each process executed by the acquisition unit F210, each process executed by the generation unit F220, and each process executed by the transmission unit F230 may be executed by different computers.

The route management database D210 is constructed by a program of a database management system (DBMS), which is executed by the processor 201. Specifically, the route management database D210 is constructed when the DBMS program manages the data stored in the secondary storage unit 203. The route management database D210 may be a relational database.

The route management database D210 stores information on the user's passage route. Here, the “passage route” is a route through which the elementary school student (the user) attending the elementary school in the predetermined area passes when going to and leaving school. In the route management database D210, the user and the information on the passage route are associated with each other. Here, a configuration example of the information stored in the route management database D210 will be described with reference to FIG. 5. FIG. 5 is a diagram illustrating an example of a table configuration of the information stored in the route management database D210. The configuration of the table stored in the route management database D210 (hereinafter, sometimes referred to as a “route information table”) is not limited to the example illustrated in FIG. 5, and fields can be added, changed, or deleted as appropriate. In addition, the route information table as illustrated in FIG. 5 is generated for each predetermined area under the management of the server apparatus 200. In other words, the route management database D210 stores a plurality of route information tables generated for each predetermined area under the management of the server apparatus 200.

The route information table illustrated in FIG. 5 has fields of a user ID, a passage route, a first time range, and a second time range. In the user ID field, information for identifying each user (the user ID) is registered. Here, the “user ID” is information for distinguishing each user from other users, and does not need to include personal information of each user. In the passage route field, information on a route (a passage route) through which each user passes when going to and leaving school from among the routes in the predetermined area is registered. In the first time range field, information on a time range (a school going time range) in which each user passes through the passage route when going to school is registered. In the second time range field, information on a time range (a school leaving time range) in which each user passes through the passage route when leaving school is registered.

In the first time range field, the school going time range declared in advance by each user may be registered. The information registered in the first time range field may be updated as appropriate according to a start time of a school day, a start time of a club activity, or the like of each user. Alternatively, the information registered in the first time range field may be updated as appropriate according to a time at which each user actually departs from his/her home. In the second time range field, the school leaving time range declared in advance by each user may be registered. The information registered in the second time range field may be updated as appropriate according to a finish time of the school day, a finish time of the club activity, or the like of each user. Alternatively, the information registered in the second time range field may be updated as appropriate according to a time at which each user actually leaves the elementary school. Information on each user's start time, club activity start time, departure time from home, finish time, club activity finish time, school leaving time, and the like may be provided from the home or the elementary school, or may be acquired by analyzing an image captured by a surveillance camera installed at home or in the elementary school. Alternatively, the first time range and the second time range may be updated as appropriate based on the current position information and the like acquired via a GPS communication device carried by each user. At that time, for example, a moving speed of each user may be obtained by monitoring the current position of each user in time series, and the first time range or the second time range may be predicted from the obtained moving speed and the current position. Alternatively, the current position and the moving speed of each user can be obtained by analyzing images captured by surveillance cameras installed at a plurality of locations within the predetermined area, and the first time range or the second time range may be predicted from the obtained moving speed and current position.

The information registered in the passage route field may be generated based on the school commuting route declared in advance by each user. The information registered in the passage route field may be updated as appropriate based on the current position information, and the like, acquired via the GPS communication device carried by each user. At that time, for example, the proceeding direction of each user may be obtained by monitoring the current position of each user in time series, and the passage route may be predicted from the obtained proceeding direction and current position. Alternatively, the current position and the proceeding direction of each user may be obtained by analyzing images captured by the surveillance cameras installed at the locations within the predetermined area, and the passage route may be predicted from the obtained proceeding direction and current position.

The acquisition unit F210 acquires the passage route information. In this example, the acquisition unit F210 acquires the passage route information when the communication unit 204 receives the provisional information from the vehicle 100. In this example, the “acquisition of the passage route information” means specification and/or acquisition of the route information table corresponding to the predetermined area in which the vehicle 100 is scheduled to travel. Specifically, the acquisition unit F210 first specifies the predetermined area through which the provisional scheduled traveling route, included in the provisional information, passes. The acquisition unit F210 accesses the route management database D210 and specifies the route information table corresponding to the predetermined area specified above. The information on the predetermined area specified by the acquisition unit F210 and the route information table are transferred from the acquisition unit F210 to the generation unit F220. At that time, the route information table itself may be transferred from the acquisition unit F210 to the generation unit F220, or information on a storage position of the route information table may be transferred from the acquisition unit F210 to the generation unit F220. When the provisional scheduled traveling route does not pass through any of the predetermined areas under the control of the server apparatus 200, the acquisition unit F210 transmits the above-described approval information to the vehicle 100 via the communication unit 204.

The generation unit F220 generates the recommended information. As described above, here, the “recommended information” is information on a vehicle traveling route (the recommended route) recommended within the predetermined area. In generating the recommended information, the generation unit F220 first extracts all the route candidates within the predetermined area specified by the acquisition unit F210. Here, the “route candidates” are routes through which the vehicle 100 can pass within the predetermined area. Referring to the route information table specified by the acquisition unit F210, the generation unit F220 calculates the score of each of the extracted route candidates. Here, the “score” is an evaluation value on the safety level when the vehicle 100 is assumed to pass on each route candidate, and is calculated such that the score becomes higher as the number of passers-by from among the users on a route candidate is smaller. This is because the probability of an occurrence of a minor accident between the vehicle 100 and the user during the traveling of the vehicle 100 is predicted to become lower as the number of passers-by from among the users on the route candidate is smaller.

Here, procedures for calculating the score of each route candidate will be described in detail. In this example, the score of each route candidate is calculated according to the following three procedures:

(Procedure 1-1) The generation unit F220 predicts the time range (the scheduled traveling time range) in which the vehicle 100 is scheduled to travel in the predetermined area based on the provisional scheduled traveling route and the current position of the vehicle 100. For example, the generation unit F220 predicts the scheduled traveling time range by calculating a required time for the vehicle 100 to reach the predetermined area from the current position and adding the calculated required time to the current time. At that time, the required time may be calculated based on a distance of a section from the current position to the predetermined area on the provisional scheduled traveling route, the road information in the section (for example, traffic congestion information or traffic regulation information), and the like.

(Procedure 1-2) The generation unit F220 predicts the number of users passing through each route candidate (the number of passers-by for each route candidate) in the scheduled traveling time range. Specifically, first, referring to the route information table corresponding to the predetermined area, the generation unit F220 extracts all the users having school going time ranges or school leaving time ranges overlapping the scheduled traveling time range, which are registered in the first time range field or the second time range field. The generation unit F220 calculates the number of extracted users for each passage route by totaling the number of passers-by for each passage route. The generation unit F220 calculates the number of passers-by for each route candidate based on the number of passers-by for each route. Specifically, the generation unit F220 calculates the number of passers-by on all the passage routes included in each route candidate by totaling the number of passers-by for each route candidate. For example, for a route candidate including at least a part of a passage route R0001 and at least a part of a passage route R0002, the generation unit F220 calculates the number of passers-by on the route candidate by totaling the number of passers-by of the passage route R0001 and the number of passers-by of the passage route R0002. The number of passers-by in each route candidate can be obtained by executing such calculation processing for all route candidates.

(Procedure 1-3) The generation unit F220 calculates the score of each route candidate based on the number of passers-by for each route candidate. At that time, as described above, the generation unit F220 calculates the score such that the score becomes higher as the number of passers-by on the route candidate is smaller.

When the score for each route candidate is calculated using the above-described procedure, the generation unit F220 selects the route candidate having the highest score from among the route candidates. The generation unit F220 sets the selected candidate as the recommended route.

Upon setting the recommended route, the generation unit F220 generates the recommended information including a command to set the scheduled traveling route within the predetermined area as the recommended route. The recommended information generated by the generation unit F220 is transferred from the generation unit F220 to the transmission unit F230. In addition to the above-described command, the recommended information may include a command to slowly travel at any point (for example, a point through which the user is passing) on the recommended route. Moreover, the recommended information may include a command to pause at any point (for example, before the point through which the user is passing) on the recommended route.

The transmission unit F230 transmits the approval information generated by the acquisition unit F210, the recommended information generated by the generation unit F220, or the like to the vehicle 100 via the communication unit 204.

### Flow of Processing

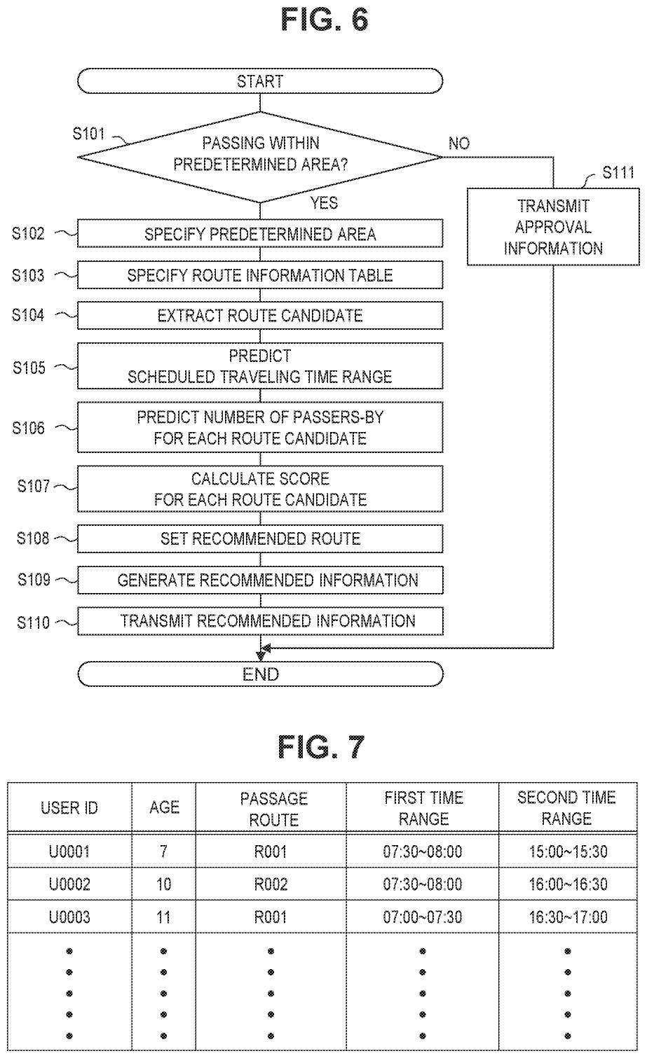

Next, a flow of processing executed by the server apparatus 200 of the present embodiment will be described with reference to FIG. 6. FIG. 6 is a flowchart illustrating a flow of processing executed in the server apparatus 200 when receiving the provisional information from the vehicle 100.

In FIG. 6, when the communication unit 204 of the server apparatus 200 receives the provisional information from the vehicle 100, the acquisition unit F210 determines whether the provisional traveling route passes through any of a plurality of predetermined areas under the control of the server apparatus 200 (step S101).

When the provisional scheduled traveling route does not pass through any of the predetermined areas under the control of the server apparatus 200 (a negative determination in step S101), the acquisition unit F210 transmits the approval information to the vehicle 100 via the communication unit 204 (step S111).

On the other hand, when the provisional scheduled traveling route passes through any of the predetermined areas under the control of the server apparatus 200 (a positive determination in step S101), the acquisition unit F210 specifies a predetermined area through which the provisional scheduled traveling route passes (step S102).

Upon specifying the predetermined area through which the provisional scheduled traveling route passes, the acquisition unit F210 specifies a route information table corresponding to the predetermined area specified in step S102 from among the route information tables stored in the route management database D210 (step S103).

The information on the predetermined area and the route information table specified in steps S102 and S103 are transferred from the acquisition unit F210 to the generation unit F220.

The generation unit F220 extracts all the route candidates within the predetermined area specified in step S102 (step S104).

The generation unit F220 predicts a time range (the scheduled traveling time range) in which the vehicle 100 is scheduled to travel within the predetermined area specified in step S102 (step S105). At that time, as described in the above-described procedure 1-1, the generation unit F220 first calculates the time required for the vehicle 100 to reach the predetermined area from the current position. In other words, the generation unit F220 calculates the required time based on the distance of the section from the current position to the predetermined area on the provisional scheduled traveling route, the road information in the section, and the like. The generation unit F220 predicts the scheduled traveling time range by adding the required time to the current time.

Referring to the route information table specified in step S103 based on the scheduled traveling time range predicted in step S105, the generation unit F220 predicts the number of passers-by for each route candidate (step S106). Specifically, as described in the above-described procedure 1-2, the generation unit F220 first extracts all the users having school going time ranges or school leaving time ranges overlapping the scheduled traveling time range predicted in step S105, which are registered in the first time range field or the second time range field. The generation unit F220 totals the number of extracted users for each passage route. Specifically, the generation unit F220 calculates the number of passers-by in all the passage routes included in each route candidate by totaling the number of passers-by in all the passage routes included in each route candidate.

The generation unit F220 calculates the score of each route candidate based on the number of passers-by for each route candidate, predicted in step S106 (step S107).

Specifically, as described in the above-described procedure 1-3, the generation unit F220 calculates the score such that the score becomes higher as the number of passers-by on the route candidate is smaller.

The generation unit F220 sets the recommended route based on the score calculated in step S107 (step S108). In other words, the generation unit F220 sets, as the recommended route, the route candidate having the highest score calculated in step S107 from among all the route candidates within the predetermined area.

The generation unit F220 generates the recommended information based on the recommended route set in step S108 (step S109). At that time, the generated recommended information includes information for identifying the recommended route, a command to set the scheduled traveling route within the predetermined area as the recommended route, and the like. The recommended information generated as above is transferred from the generation unit F220 to the transmission unit F230.

The transmission unit F230 transmits the recommended information received from the generation unit F220 to the vehicle 100 via the communication unit 204 (step S110). In that case, in the vehicle 100 that has received the recommended information, the operation plan generation unit F110 sets an official scheduled traveling route according to the command included in the recommended information. In other words, the operation plan generation unit F110 corrects the provisional scheduled traveling route to a route that passes through the recommended route, and sets the corrected route as the official scheduled traveling route.

According to the processing routine of FIG. 6, the vehicle 100 scheduled to travel within the predetermined area can travel within the predetermined area according to the recommended route set by the server apparatus 200. At that time, since the recommended route is a route predicted to have the smallest number of passers-by from among the users in the scheduled traveling time range from among the route candidates within the predetermined area, it is possible to reduce the probability of an occurrence of a minor accident between the vehicle 100 and the user.

Therefore, with the present embodiment, it is possible to improve traffic safety of elementary school students (users) who attend an elementary school within a predetermined area when going to and leaving school.

### Second Embodiment

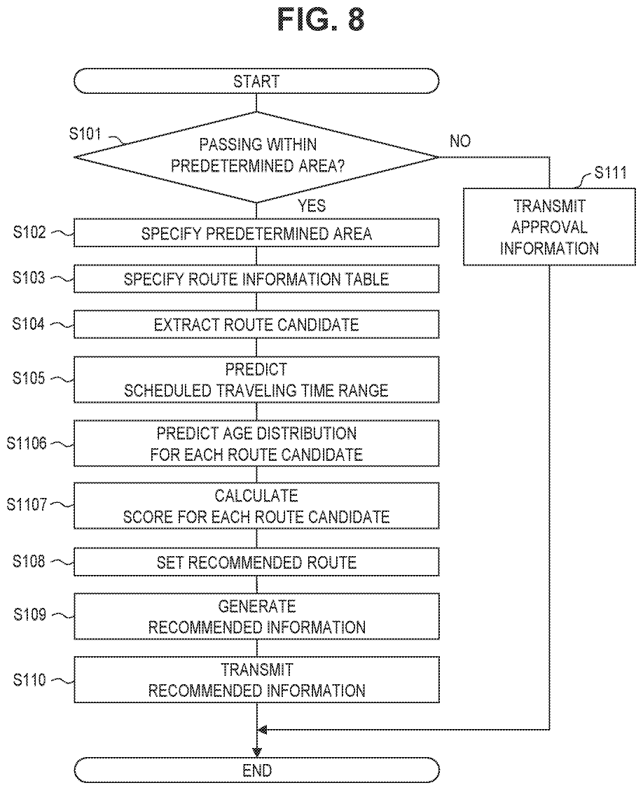

A second embodiment of the present disclosure will be described with reference to FIGS. 7 and 8. Here, a configuration different from that of the above-described first embodiment will be described, and the description of the same configuration as that of the first embodiment will be omitted.

The difference between the above-described first embodiment and the present embodiment is the method of determining the score of a route candidate. In other words, in the above-described first embodiment, an example in which the score is determined based on the number of passers-by on each route candidate has been described, but in the present embodiment, the score is determined based on the age distribution of the users passing through each route candidate.

FIG. 7 is a diagram illustrating a configuration example of a route information table in the present embodiment. In the present embodiment, the route information table has an age field in addition to fields of, for example, the user ID, the passage route, the first time range, and the second time range. Information registered in each field of the user ID, the passage route, the first time range, and the second time range is the same as that in the above-described first embodiment (see FIG. 5). In the age field, information on the age of each user is registered. In the age field, information indicating the age of each user may be registered, or information indicating the grade of each user may be registered.

Here, procedures in which the generation unit F220 in the present embodiment calculates the score of each route candidate will be described. In the present embodiment, the score of each route candidate is calculated according to the following three procedures:

(Procedure 2-1) The generation unit F220 predicts the scheduled traveling time range. A method of predicting the scheduled traveling time range is the same as the procedure 1-1 in the above-described first embodiment.

(Procedure 2-2) The generation unit F220 predicts the age distribution of the users passing through each route candidate (the age distribution for each route candidate) in the scheduled time range. Here, the “age distribution” may be, for example, the number of passers-by for each age or the number of passers-by for each grade. In predicting the age distribution, first, referring to the route information table corresponding to the predetermined area in which the vehicle 100 is scheduled to travel, the generation unit F220 extracts, for each passage route, all the users having school going time ranges or school leaving time ranges overlapping the scheduled traveling time range, which are registered in the first time range field or the second time range field. The generation unit F220 classifies the users, extracted for each passage route, by a route candidate. For example, for a route candidate including at least a part of the passage route R0001 and at least a part of the passage route R0002, a combination of the extracted user in association with the passage route R0001 and the user in association with the passage route R0002 are classified into the users corresponding to the route candidate. The generation unit F220 generates the age distribution of the users classified by the route candidate.

(Procedure 2-3) The generation unit F220 calculates the score of each route candidate based on the age distribution for each route candidate. At that time, the generation unit F220 obtains the proportion of the users in a predetermined young age group (for example, the age group corresponding to the lower grades of elementary school) in the age distribution for each route candidate. In other words, the generation unit F220 obtains a proportion of the number of passers-by from among the users in the predetermined young age group, from among the users passing through each route candidate (hereinafter, sometimes referred to as an “occupancy proportion”). The generation unit F220 calculates the score such that the score becomes higher as the route candidate has a smaller occupancy proportion.

Alternatively, the generation unit F220 may obtain the average age (or the average grade) in the age distribution for each route candidate, and calculate the score such that the score becomes higher as the route candidate has a higher average age (or the average grade). This is because the probability of an occurrence of a minor accident between the users in the lower grades and the vehicle 100 is predicted to be reduced since the number of users in the higher grades who can pay attention to the users in the lower grades becomes larger as the occupancy proportion is smaller or the average age is higher.

### Flow of Processing

Next, a flow of processing executed by the server apparatus 200 in the present embodiment will be described with reference to FIG. 8. FIG. 8 is a flowchart illustrating a flow of processing executed in the server apparatus 200 when receiving the provisional information from the vehicle 100. In FIG. 8, the same processing as that of above-described first embodiment (the flowchart of FIG. 6) will be denoted by the same step number as that of FIG. 6.

In the flow of processing of FIG. 8, the processes of steps S1106 and S1107 are executed instead of steps S106 and S107 of the above-described flow of processing of FIG. 6.

In step S1106, referring to the route information table specified in step S103 based on the scheduled traveling time range predicted in step S105, the generation unit F220 predicts the age distribution for each route candidate in the scheduled traveling time range. Specifically, as described in the above-described procedure 2-2, the generation unit F220 first extracts, for each passage route, all the users having school going time ranges or school leaving time ranges overlapping the scheduled traveling time range predicted in step S105, which are registered in the first time range field or the second time range field. The generation unit F220 classifies the users, extracted for each passage route, by a route candidate. The generation unit F220 generates the age distribution based on the number and the age (or the grade) of the users classified by a route candidate.

In step 51107, the generation unit F220 calculates the score of each route candidate based on the age distribution for each route candidate generated in step S1106.

Specifically, as described in the above-described procedure 2-3, the generation unit F220 calculates the occupancy proportion or the average age (or the average grade) in the age distribution for each route candidate. The generation unit F220 calculates the score such that the score becomes higher as the route candidate has a smaller calculated occupancy proportion or the route candidate has a higher calculated average age (or the average grade).

According to the processing routine of FIG. 8, the recommended route set by the server apparatus 200 is the route in which the occupancy proportion of the users who pass in the scheduled traveling time range is predicted to be the smallest, or the route in which the average age (or average grade) of the users who pass in the scheduled traveling time range is predicted to be the highest. As a result, it is possible to reduce the probability of an occurrence of a minor accident between the vehicle 100 and the users in the predetermined young age group.

Among the route candidates included in the predetermined area, when there is a route candidate of which the number of passers-by from among the users is zero, and a route candidate of which the number of passers-by from among the users is equal to or greater than one but the number of passers-by from among the users in a predetermined young age group is zero, the occupancy proportion of both will be 0%. In such a case, the generation unit F220 may set, as the recommended route, the route candidate of which the number of passers-by from among the users is zero.

Therefore, with the present embodiment, it is possible to improve traffic safety of elementary school students (users) attending an elementary school, especially when the users in a predetermined young age group go to and leave school.

### Third Embodiment

Next, a third embodiment of the present disclosure will be described. Here, a configuration different from the above-described first and second embodiments will be described, and the description of same configurations as those of the first and second embodiments will be omitted.

The difference between the above-described first embodiment and the second embodiment is the method of determining the score of a route candidate. In other words, in the above-described first and second embodiments, an example in which the score is determined based on only one of the number of passers-by for each route candidate and the age distribution for each route candidate has been described. However, in the present embodiment, the score of each route candidate is determined based on both the number of passers-by for each route candidate and the age distribution for each route candidate.

In the present embodiment, the generation unit F220 calculates the score of each route candidate according to the following four procedures:

(Procedure 3-1) The generation unit F220 acquires the scheduled traveling time range. A method of predicting the scheduled traveling time range is the same as the procedure 1-1 in the above-described first embodiment.

(Procedure 3-2) The generation unit F220 predicts the number of passers-by for each route candidate. A method of predicting the number of passers-by for each route candidate is the same as that of the procedure 1-2 in the above-described first embodiment.

(Procedure 3-3) The generation unit F220 predicts the age distribution for each route candidate. A method of predicting the age distribution for each route candidate is the same as that of the procedure 2-2 in the above-described second embodiment.

(Procedure 3-4) The generation unit F220 calculates the score of each route candidate based on the number of passers-by and the age distribution for each route candidate. At that time, the generation unit F220 may calculate the score such that the score becomes higher as the number of passers-by for each route candidate is smaller and the occupancy proportion in the age distribution for each route candidate is smaller. Alternatively, the generation unit F220 may calculate the score such that the score becomes higher as the number of passers-by for each route candidate is smaller and the average age (or the average grade) in the age distribution for each route candidate is higher.

According to the present embodiment, a route candidate of which the number of passers-by from among the users is relatively small and the occupancy proportion in the age distribution of the users is relatively small (or the average age (or the average grade) in the age distribution of the users is relatively high) is set as the recommended route. As such, it is possible to further improve traffic safety of elementary school students (users) attending an elementary school when going to and leaving school.

### Others

The above-described first to third embodiments are mere examples, and can be appropriately modified and implemented within a range not departing from the scope of the present disclosure. For example, in the above-described first to third embodiments, as the vehicle 100 scheduled to travel in the predetermined area, an automobile (an autonomous driving vehicle) capable of autonomously traveling on a road by autonomous driving is exemplified, but may be an automobile (a manually driven vehicle) capable of traveling on the road by a manual operation of a driver. In that case, a car navigation system mounted on the manually driven vehicle may provide route guidance to the driver based on the recommended route set by the server apparatus 200. In addition, when the recommended information includes a command for slowly traveling or temporarily pausing, the driver may be called to attention according to the above information (for example, a voice message for urging to slowly travel or for urging to temporarily pause is output).

Further, in the above-described first to third embodiments, an example in which the recommended information is transmitted to a vehicle of which the provisional scheduled traveling route passes through the predetermined area has been described, but the recommended information may be transmitted all at once to vehicles traveling within a predetermined distance from the boundary of the predetermined area. In that case, in the vehicle that has received the recommended information, it may be determined whether the scheduled traveling route of the vehicle passes through the predetermined area. When it is determined that the scheduled traveling route of the vehicle passes through the predetermined area, the scheduled traveling route of the vehicle may be changed to a route that passes through the recommended route.

Moreover, the processes and/or elements described in the present disclosure can be freely combined and implemented within a range in which no technical contradiction arises. In addition, the processing described as being executed by one device may be shared and executed by a plurality of devices. Alternatively, the processing described as being executed by different devices may be executed by one device. In the computer system, which hardware configuration implements each function can be flexibly changed. For example, the processing on the acquisition unit F210 and the processing on the generation unit F220 of the server apparatus 200 may be executed on the vehicle 100 side.

In addition, the present disclosure can also be implemented by supplying a computer program (an information processing program) having the functions described in the embodiments into a computer, and reading and executing the program by one or more processors included in the computer. Such a computer program may be provided to a computer by a non-transitory computer-readable storage medium that can be connected to a system bus of the computer, or may be provided to the computer or via a network. The non-transitory computer-readable storage medium is a recording medium in which information such as data and programs is accumulated by an electrical, magnetic, optical, mechanical, or chemical action and from which the information can be read by the computer or the like. Examples of such a non-transitory computer-readable storage medium include any kind of disk, such as a magnetic disk (a floppy disk®, an HDD, and the like) and an optical disk (a CD-ROM, a DVD disk, a Blu-ray disk, and the like). A non-transitory computer-readable storage medium may be a ROM, a RAM, an EPROM, an EEPROM, a magnetic card, a flash memory, an optical card, a solid state drive (SSD), or the like.

What is claimed is:

1. An information processing apparatus that manages an operation of a vehicle, the information processing apparatus comprising:
a control unit configured to:
acquire information on a passage route that is a route through which a user of a facility included in a predetermined area passes;
generate, based on the information on the passage route, information on a recommended route that is a vehicle traveling route recommended within the predetermined area; and
transmit the information on the recommended route to the vehicle scheduled to travel within the predetermined area.

2. The information processing apparatus according to claim 1, wherein the control unit is configured to:
extract a plurality of route candidates that are candidates of routes through which the vehicle is allowed to pass when traveling within the predetermined area;
calculate, based on the information on the passage route, a score on a safety level when the vehicle is assumed to travel on each of the route candidates; and
set, as the recommended route, a route candidate having a highest score from among the route candidates.

3. The information processing apparatus according to claim 2, wherein:
when a plurality of users and a plurality of passage routes are present, the information on the passage route includes information on a time range in which at least one of the users passes through each of the passage routes; and
the control unit is configured to:
acquire a scheduled traveling time range that is a time range in which the vehicle is scheduled to travel in the predetermined area;
predict, based on the information on the passage route, the number of passers-by from among the users in the scheduled traveling time range for each of the route candidates; and
calculate, based on the number of passers-by from among the users for each of the route candidates, the score for each of the route candidates.

4. The information processing apparatus according to claim 3, wherein the control unit is configured to calculate the score such that the score is larger when the number of passers-by from among the users for each of the route candidates is small than when the number is large.

5. The information processing apparatus according to claim 2, wherein:
when a plurality of users and a plurality of passage routes are present, the information on the passage route includes information on a time range in which at least one of the users passes through each of the passage routes; and
the control unit is configured to:
acquire a scheduled traveling time range that is a time range in which the vehicle is scheduled to travel in the predetermined area;
acquire age information that is information on an age of each of the users;
predict, based on the information on the passage route and the age information, an age distribution of the users in the scheduled traveling time range for each of the route candidates; and
calculate, based on the age distribution of the users for each of the route candidates, the score for each of the route candidates.

6. The information processing apparatus according to claim 5, wherein the control unit is configured to calculate the score such that the score is higher when a proportion of a predetermined young age group in the age distribution of the users for each of the route candidates is small than when the proportion is large.

7. The information processing apparatus according to claim 6, wherein:
the facility is an elementary school;
the user is a child who commutes to and/or from the elementary school; and
the predetermined young age group is an age group corresponding to lower grades of the elementary school.

8. The information processing apparatus according to claim 5, wherein the control unit is configured to calculate the score such that the score is higher when an average age in the age distribution of the users for each of the route candidates is high than when the average age is low.

9. The information processing apparatus according to claim 8, wherein:
the facility is an elementary school; and
the user is a child who commutes to and/or from the elementary school.

10. The information processing apparatus according to claim 2, wherein:
when a plurality of users and a plurality of passage routes are present, the information on the passage route includes information on a time range in which at least one of the users passes through each of the passage routes; and
the control unit is configured to:
acquire a scheduled traveling time range that is a time range in which the vehicle is scheduled to travel in the predetermined area;
predict, based on the information on the passage route, the number of passers-by from among the users in the scheduled traveling time range for each of the route candidates,
acquire age information that is information on an age of each of the users;
predict, based on the information on the passage route and the age information, an age distribution of the users in the scheduled traveling time range for each of the route candidates; and
calculate, based on the number of passers-by from among the users and the age distribution for each of the route candidates, the score for each of the route candidates.

11. The information processing apparatus according to claim 10, wherein the control unit is configured to calculate the score such that the score becomes higher as the number of passers-by from among the users for each of the route candidates is smaller and a proportion of a predetermined young age group in the age distribution of the users for each of the route candidates is smaller.

12. The information processing apparatus according to claim 11, wherein:
the facility is an elementary school;
the user is a child who commutes to and/or from the elementary school; and
the predetermined young age group is an age group corresponding to the lower grades of the elementary school.

13. The information processing apparatus according to claim 10, wherein the control unit is configured to calculate the score such that the score becomes higher as the number of passers-by from among the users for each of the route candidates is smaller and the average age in the age distribution of the users for each of the route candidates is higher.

14. The information processing apparatus according to claim 13, wherein:
the facility is an elementary school; and
the user is a child who commutes to and/or from the elementary school.

15. An information processing method of managing an operation of a vehicle, the information processing method comprising:
a first step of acquiring information on a passage route that is a route through which a user of a facility included in a predetermined area passes;
a second step of generating, based on the information on the passage route, information on a recommended route that is a vehicle traveling route recommended within the predetermined area; and
a third step of transmitting the information on the recommended route to the vehicle scheduled to travel within the predetermined area, the first step, the second step, and the third step being executed by a computer.

16. The information processing method according to claim 15, wherein the second step includes:
a step of extracting a plurality of route candidates that are candidates of routes through which the vehicle is allowed to pass when traveling within the predetermined area;
a step of calculating, based on the information on the passage route, a score on a safety level when the vehicle is assumed to travel on each of the route candidates; and
a step of setting, as the recommended route, a route candidate having a highest score from among the route candidates.

17. The information processing method according to claim 16, wherein:
when a plurality of users and a plurality of passage routes are present, the information on the passage route includes information on a time range in which at least one of the users passes through each of the passage routes; and
the step of calculating the score includes:
a step of acquiring a scheduled traveling time range that is a time range in which the vehicle is scheduled to travel in the predetermined area;
a step of predicting, based on the information on the passage route, the number of passers-by from among the users in the scheduled traveling time range for each of the route candidates; and
a step of calculating, based on the number of passers-by from among the users for each of the route candidates, the score for each of the route candidates.

18. The information processing method according to claim 16, wherein:
when a plurality of users and a plurality of passage routes are present, the information on the passage route includes information on a time range in which at least one of the users passes through each of the passage routes; and
the step of calculating the score includes:
a step of acquiring a scheduled traveling time range that is a time range in which the vehicle is scheduled to travel in the predetermined area;
a step of acquiring age information that is information on an age of each of the users;
a step of predicting, based on the information on the passage route and the age information, an age distribution of the users in the scheduled traveling time range for each of the route candidates; and
a step of calculating, based on the age distribution of the users for each of the route candidates, the score for each of the route candidates.

19. The information processing method according to claim 16, wherein:
when a plurality of users and a plurality of passage routes are present, the information on the passage route includes information on a time range in which at least one of the users passes through each of the passage routes; and
the step of calculating the score includes:
a step of acquiring a scheduled traveling time range that is a time range in which the vehicle is scheduled to travel in the predetermined area;
a step of predicting, based on the information on the passage route, the number of passers-by from among the users in the scheduled traveling time range for each of the route candidates;
a step of acquiring age information that is information on an age of each of the users;
a step of predicting, based on the information on the passage route and the age information, an age distribution of the users in the scheduled traveling time range for each of the route candidates; and
a step of calculating, based on the number of passers-by from among the users and the age distribution for each of the route candidates, the score for each of the route candidates.

20. A vehicle comprising:
a control unit configured to:
acquire information on a passage route that is a route through which a user of a facility included in a predetermined area passes;
set, based on the information on the passage route, a recommended route that is a vehicle traveling route recommended within the predetermined area; and
execute an operation by which the vehicle travels within the predetermined area according to the recommended route.
